(19) United States
(12) Patent Application Publication
(10) Pub. No.: US 2026/0208380 A1
(43) Pub. Date: Jul. 23, 2026

(54) Umbilical cable cutting device

(71) Applicant: VIETTEL GROUP, Ha Noi City (VN)

(72) Inventors: MANH CUONG NGUYEN, Ha Noi City (VN); XUAN DONG NGUYEN, Ha Noi City (VN); ANH TUAN CAO, Ha Noi City (VN); VAN THIEN NGUYEN, Ha Noi City (VN); VAN TUNG PHAM, Ha Noi City (VN); THO TUAN LEE, Ha Noi City (VN); XUAN SON NGUYEN, Ha Noi City (VN); TRAN MINH DUC NGO, Ha Noi City (VN)

(73) Assignee: VIETTEL GROUP, Ha Noi City (VN)

(21) Appl. No.: 19/336,179

(22) Filed: Sep. 22, 2025

(30) Foreign Application Priority Data
Jan. 22, 2025 (VN) 1-2025-00510

(51) Int. Cl. B26D 7/26; B26D 1/00; B64D 47/00; B64F 1/35

(52) U.S. Cl. CPC B26D 7/2614; B26D 1/0006; B64D 47/00; B64F 1/35; B26D 2001/002; B64D 2221/00

(57) ABSTRACT

An umbilical cable cutting device for disconnecting the electrical and communication connections between an aircraft and power supply and/or control unit located outside the guide tube. includes a base plate with opening receiving the umbilical cable and another rectangular opening behind the first opening, the second opening accommodating a flat cutter and drive mechanism, the base plate upper surface having a cutting groove from the middle of the second opening extending laterally and through the first opening toward the base plate’s front edge; The cutter is mounted in the cutter track and moves in the track by a drive mechanism, the drive mechanism includes a push pin to rest on the flying device’s push pin. When the flying device is launched, the flying device’s push pin pushes the drive mechanism’s push trigger of the to cause the flat cutter to move forward to cut the umbilical cable.

### FIELD OF INVENTION

The invention covers the field of aviation. More specifically, the invention covers an umbilical cable cutting device for a guided-tube deployed aircraft.

### BACKGROUND OF THE INVENTION

In general, guided-tube deployed aircraft typically include an umbilical cable for electrical and/or communication connections to the aircraft power supply and/or control unit located outside the guide tube. The umbilical cable is used prior to the launch of the aircraft and is cut or disconnected prior to or simultaneously with the launch of the aircraft.

Currently, the umbilical cable disconnection is typically accomplished by using a self-disconnecting connector, where the self-disconnecting connector is constructed with a male and female connector that can be assembled/disassembled together. In the aircraft ready-to-operate state, the male connector is assembled with the female connector to provide electrical and/or communication connections between the aircraft and the aircraft power supply and/or control unit. When the aircraft is launched, the male jack is separated from the female jack to disconnect the power and communication between the aircraft and the power source and/or the aircraft controller.

In practice, the option of using a self-disconnecting jack to connect and disconnect the umbilical cable is considered effective. However, according to this option, the female jack of the self-disconnecting jack mechanism is fixed on the aircraft body, so there are still some disadvantages as follows:

In case the female jack is arranged completely inside the aircraft body, it will occupy the space inside the aircraft, affecting the assembly and arrangement of other equipment.

In case the female jack is arranged to protrude outside the aircraft body, it will affect the aerodynamics of the aircraft. In addition, the guide tube used in this case must also be made larger to avoid collision with the aircraft.

Therefore, the need for a device to disconnect the electrical and/or communication between the aircraft and the power source and/or the aircraft controller that overcomes the above-mentioned disadvantages is extremely necessary.

### SUMARY OF INVENTION

The purpose of the invention is to provide an umbilical cable cutting device for an aircraft deployed in a guide tube to disconnect the electrical and/or communication connection between the aircraft and the power supply and/or the aircraft controller when the aircraft is launched in order to overcome the above-mentioned disadvantages.

To achieve this purpose, the umbilical cable cutting device according to an embodiment of the invention is structured to include:

a base plate (10) comprising a first opening (11) for receiving the umbilical cable (200) and a second opening (12) in a rectangular shape located behind the first opening (11);

the upper surface of the base plate (10) has a knife track (18) formed from the middle of the second opening (12) extending to both sides and extending through the first opening (11) towards the front edge (10a) of the base plate (10);

a stopper plate (14) is attached to the upper surface of the base plate (10) so that it blocks at least part of the upper part of the tool groove (18);

a flat cutter (20) with a tool holder (21), the flat cutter (20) is mounted in the tool groove (18) and can move along this groove by means of a transmission mechanism (30) arranged in the space inside the second opening (12);

wherein the drive mechanism (30) is structured to include:

a V-shaped push rod (31) comprising a trigger arm (311) and a push arm (312), the push rod (31) being rotatably attached to the rear horizontal edge (12b) of the second opening (12) at its V-shaped bottom position by a first pivot pin (33a),

the crank arm (32) having a first end connected to the knife holder base (21) of the flat cutter (20) and a second end connected to the push rod (312) of the push rod (31) by the second pivot pins (33b) and third pivot pins (33c), respectively;

at least one elastic means (40) arranged on the base plate (10) to elastically pull the flat cutter (20) towards the rear of the second opening (12).

Preferably, the elastic means (40) has one end attached to the tool holder (21) of the flat cutter (20) and the other end attached to a threaded shaft (13a) on the holder (13), wherein the holder (13) is fixed behind a second opening (12) on the base plate (10).

Preferably, the threaded shaft (13a) is threaded to the holder (13), each end of the threaded shaft (13a) is fitted with an adjusting nut (13b) for adjusting the increase/decrease of the tensile force of the elastic means (40).

More preferably, the number of elastic means (40) is two.

Preferably, the elastic means (40) is a spring.

In one embodiment, the base plate (10) further includes a pair of mounting ears (121) fixed to the rear horizontal edge (12b) of the second opening (12), wherein the push trigger (31) is rotatably attached to the pair of mounting ears (121) via the first pivot pin (33a).

In another embodiment, the device further includes a clamping member (15) fixed to the base plate (10) to secure the umbilical cable (200) from moving backward against the blade of the flat cutter (20).

In another embodiment, the flat cutter (20) or at least the blade portion of the flat cutter (20) is made of non-metallic material to avoid short circuit when cutting the umbilical cable. In another embodiment, the rear surface of the trigger arm (311) is recessed with a profile suitable for the ejector pin on the aircraft.

### BRIEF DESCRIPTION OF THE DRAWINGS

The features and advantages of the umbilical cable cutting device according to the invention will be described below based on the accompanying drawings, in which:

FIG. 1 is a perspective image of the umbilical cable cutting device according to the invention;

FIG. 2 is a perspective image of the umbilical cable cutting device according to FIG. 1 in an inverted state;

FIG. 3 is a plan view of the umbilical cable cutting device according to the invention;

FIG. 4 is an E-E cross-section drawing of FIG. 3;

FIG. 5A is a longitudinal cross-section showing the umbilical cable cutting device according to the invention mounted above the opening of the guide tube, in which the cutter and the drive mechanism of this device are in a state of readiness for operation;

FIG. 5B is an enlarged image of part A of FIG. 5A;

FIG. 6A is a longitudinal cross-section showing the umbilical cable cutting device according to the invention mounted above the opening of the guide tube, in which the cutter and the drive mechanism of this device are in a state of cutting off the umbilical cable;

FIG. 6B is an enlarged view of part B of FIG. 6A;

FIG. 7A is a longitudinal section showing the umbilical cable cutting device of the invention mounted above the opening of the guide tube, in which the cutter and the drive mechanism of the device are in the state after the umbilical cable has been severed; and

FIG. 7B is an enlarged view of part C of FIG. 7A.

### DESCRIPTION OF EMBODIMENT

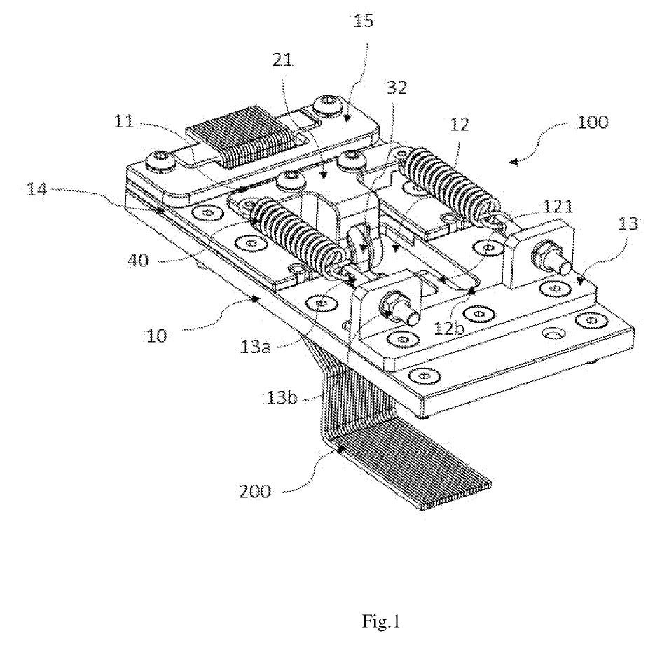

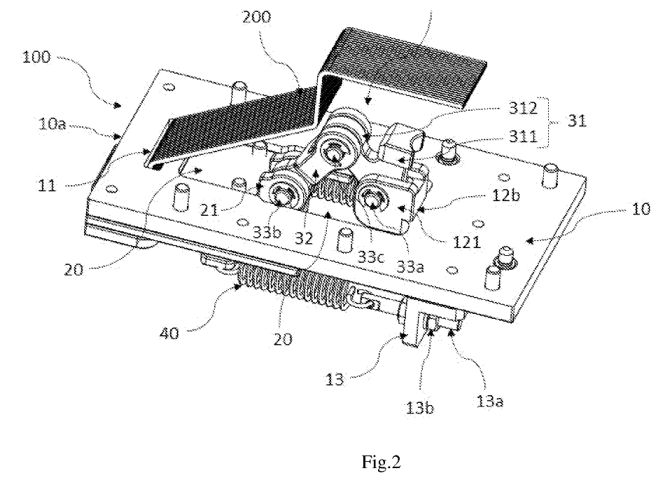

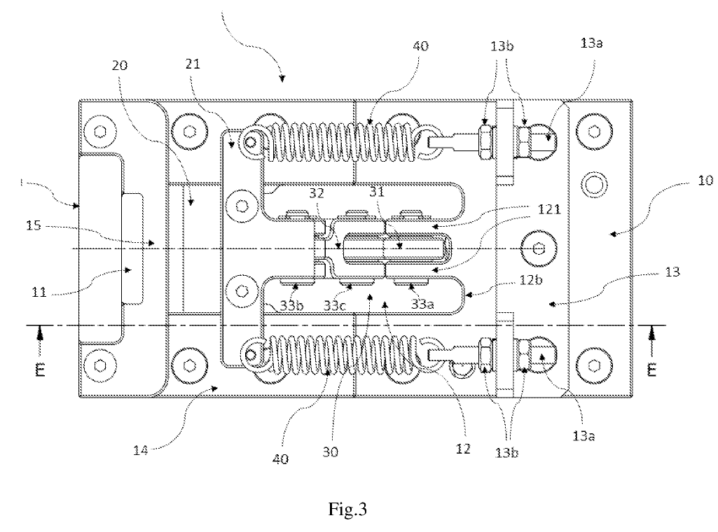

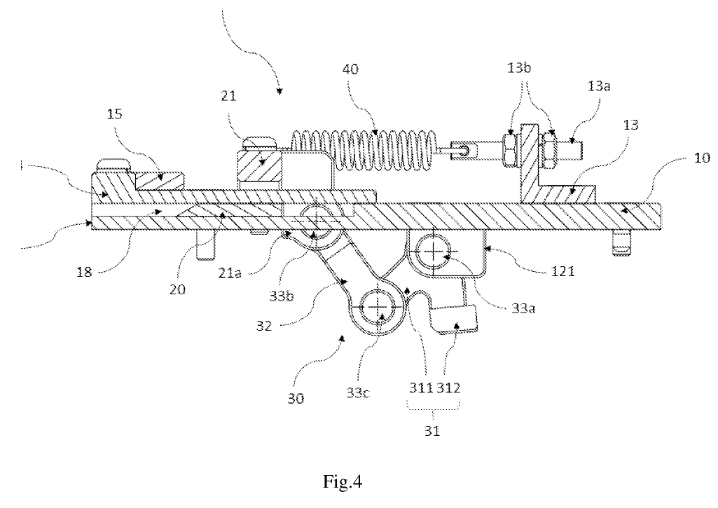

Below, the advantages, effects and nature of the invention can be better understood through the detailed description of preferred implementation embodiments based on the accompanying drawings. However, it should be understood that these embodiments are described only for the purpose of example to help better understand the nature and advantages of the invention, without limiting the scope of the invention according to these described embodiments. As shown in the drawings from FIGS. 1 to 4, the umbilical cable cutting device 100 according to the embodiment of the invention is structured to include the following main parts: a base plate 10, a flat cutter 20, a drive mechanism 30 and an elastic means 40. The base plate 10 has the function of arranging other parts of the device on it and connecting the device to the guide tube body 300. The base plate 10 is in the form of a rectangular flat plate made of metal such as aluminum, steel, stainless steel or high-strength steel, etc. The base plate 10 includes a first opening 11 for receiving the umbilical cable 200 and a second opening 12 of a rectangular profile located behind the first opening 11. The upper surface of the base plate 10 has a cutting groove 18 formed from the middle of the second opening 12 extending laterally and extending through the first opening 11 toward the front edge 10a of the base plate 10. The base plate 10 further includes bolt holes formed at the corners of the plate or at suitable locations for bolting to the guide tube body. The bolts used to connect the base plate 10 to the guide tube body are hexagonal bolts. The first opening 11 in the base plate 10 is shaped to conform to the cross-sectional shape of the umbilical cable 200. For example, the umbilical cable 200 shown in FIG. 2 is a ribbon-type umbilical cable, so the first opening 11 is shaped to be rectangular.

A flat cutter 20 of a square or rectangular shape is mounted in the cutting groove 18 of the base plate 10, the blade portion of the flat cutter 20 facing the first opening 11. In one embodiment, the flat cutter 20 or at least its blade portion is made of a non-metallic material to prevent short circuits when cutting the umbilical cable. For example, for common umbilical cables, when the flat cutter 20 cuts the umbilical cable 20, the blade of the cutter may simultaneously contact two or more cores or wires inside the umbilical cable, which may cause a short circuit. The possibility of short circuiting of the umbilical cable 200 during severing or disconnecting may be prevented or minimized by using a blade material that is non-metallic, such as ceramic, acrylic, or any other suitable non-metallic material.

In addition, the flat cutter 20 may also include a straight edge blade, a serrated edge blade, or any other suitable blade.

In another embodiment, the flat cutter 20 or at least a blade portion thereof may be made of metal for use with certain types of umbilical cables that are designed to avoid short circuiting when cut with a metal blade, such as an umbilical cable 200 having a ribbon cable construction as shown in FIG. 1 and FIG. 2. The advantage of such umbilical cable 200 is that when cut perpendicularly or substantially perpendicularly by the flat cutter, the cuts of the wires or cores do not overlap in the direction of the cut. It is understood, however, that the umbilical cable cutting device 100 according to the present invention may be used to disconnect or cut any type of umbilical cable, such as round cable, flat cable or any other structured cable.

In the case of the flat cutter 20 or at least its blade portion being made of metal, the advantage is that the cutting blade portion is very sharp and thus capable of producing a clean cut.

The flat cutter 20 may move reciprocally along the knife track 18 to perform the cutting of the umbilical cable 200 via the drive mechanism 30 arranged in the inner space of the second opening 12. The flat cutter 20 is coupled to the drive mechanism 30 via its knife holder 21.

The knife holder 21 is constructed to include a mounting plate having dimensions smaller than the width of the second opening 12 of the base plate 10 for mounting the flat cutter 20 and a connecting ear attached to the rear of the mounting plate for rotatability with the crank 32 of the drive mechanism 30. Preferably, the connecting ear is integral with the mounting plate.

The drive mechanism 30 is constructed to include a push rod 31 and a crank 32.

The push rod 31 is V-shaped and includes a rocker arm 311 and a push rod 312, the push rod 31 being rotatably mounted up and down around the rear horizontal edge 12b of the second opening 12 at its V-bottom position by a first pivot pin 33a.

The crank 32 has a first end connected to the knife holder base 21 of the flat cutter 20 and a second end connected to the push arm 312 of the push trigger 31 by means of the second pivot pins 33b and the third pivot pin 33c, respectively.

Furthermore, as shown in FIGS. 2 to 4, the base plate 10 includes a pair of mounting ears 121 fixed in the middle of the rear horizontal edge 12b of the second opening 12. In this embodiment, the push trigger 31 of the drive mechanism 30 is rotatably mounted up and down about the rear horizontal edge 12b of the second opening 12 via the pair of mounting ears 121 and the first pivot pin 33a.

Thus, with the structure as described, when the push trigger 31 rotates around the first pivot 33a from bottom to top or vice versa through the second opening 12, the crank 32 will pull and the flat cutter 20 will move according to the slider crank principle. Specifically, the flat cutter 20 will move forward or backward in the cutter groove 18 on the base plate 10 when the push trigger 31 rotates around the first pivot 33a.

As shown in the drawings from FIG. 1 to FIG. 4, the umbilical cable cutting device 100 according to the invention also includes at least one elastic means 40 arranged on the base plate 10 to elastically pull the flat cutter 20 towards the back of the second opening 12. The effect of the elastic means 40 together with the operating principle of the umbilical cable cutting device according to the invention will be described later.

As shown in FIG. 1, the umbilical cable cutting device 100 includes two elastic means 40 which are two springs arranged on the base plate 10 to elastically pull the flat cutter 20 towards the rear of the second opening 12. In this embodiment, the two springs (elastic means 40) are arranged on either side of the drive mechanism 30, wherein each spring has one end attached to the upper part of the mounting plate 211 of the knife holder base 21 and the other end attached to a corresponding threaded shaft 13a on the mounting plate 13, wherein the mounting plate 13 is fixed behind the second opening 12 on the base plate 10. Preferably, each threaded shaft 13a is fitted with two adjusting nuts 13b to enable the tension of the elastic means 40 to be adjusted to increase/decrease.

Furthermore, as shown in FIG. 1, the umbilical cable cutting device 100 according to the present invention also including a clamping member 15 fixed on the base plate 10 to hold the umbilical cable 200 in place. This embodiment has the advantage of being able to hold the umbilical cable 200 in place from moving backwards to avoid hitting the flat cutter blade 20 without having to stretch the umbilical cable portion outside the guide tube.

According to a specific implementation embodiment, the parts of the umbilical cable cutting device 100 according to the invention include a base plate 10, a mounting base 13, a stop plate 14, a clamping member 15 with a structure as described above, which are metal parts that can be shaped by known methods such as casting, CNC cutting and are connected together in a removable manner via countersunk hex bolts for convenient assembly or replacement. The use of hexagonal countersunk bolts, in addition to the aesthetic advantage, also has the advantage of not occupying space on the device, thus not occupying space and not obstructing other working parts.

Next, the operating principle of the umbilical cable cutting device 100 according to the invention and the operating principle of the elastic means 40 will be described.

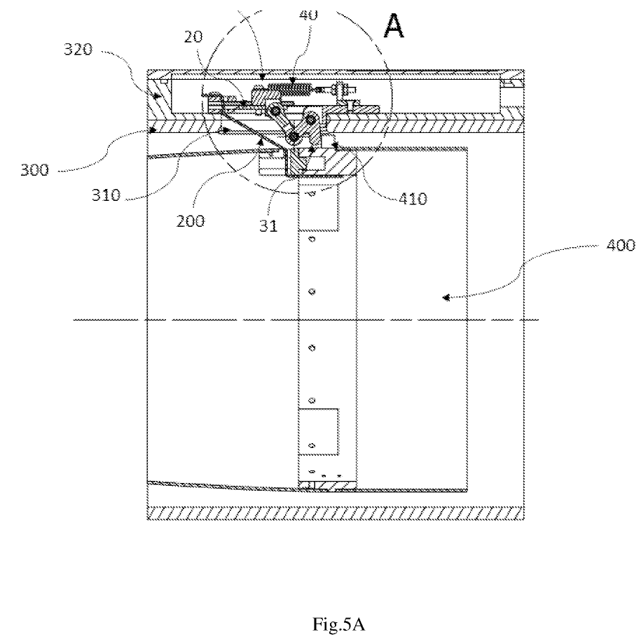

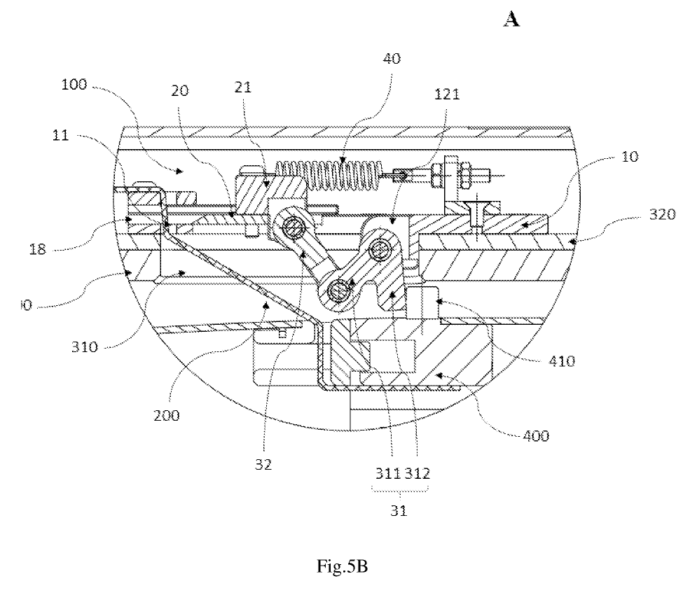

FIGS. 5A to 7B are cross-sectional views showing the installation of the umbilical cable cutting device 100 on the guide tube and the operating principle of the device. As shown in the drawings, the guide tube 300 includes a guide cavity for arranging the flying device 400 inside it and a housing 320 for installing the umbilical cable cutting device 100 arranged outside of it. The space inside the housing 320 is connected to the space inside the guide tube 300 through the opening 310. The umbilical cable cutting device 100 is mounted in the mounting compartment 320 at the opening 310.

FIG. 5A and FIG. 5B show the flying device 400 mounted in the guide tube 300 in an inactive (storage, transport) or ready-to-activate state, wherein the flying device 400 is electrically and/or communicatively connected to the power supply and/or control unit located outside the guide tube 300 via the umbilical cable 200, wherein the umbilical cable 200 is mounted through the first opening 11 on the base plate of the umbilical cable cutting device 100 mounted in the housing 320. In this state, the springs (elastic means 40) are tensioned to elastically pull the flat cutter 20 of the device toward the rear of the first opening two 12 so that the blade of the flat cutter 20 is located at a predetermined distance from the umbilical cable 200. Then, the push trigger 31 is pushed back by the flat cutter 20 via the crank 32 and the push trigger is adjusted so that the trigger arm 311 of the push trigger 31 is perpendicular to the opening 310 and the free end of the trigger arm 311 points downward through the opening 310 to press against the push pin 410 on the flying device 400.

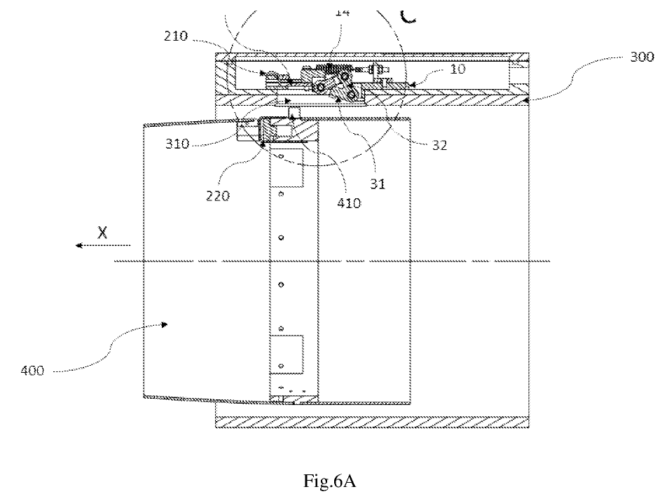

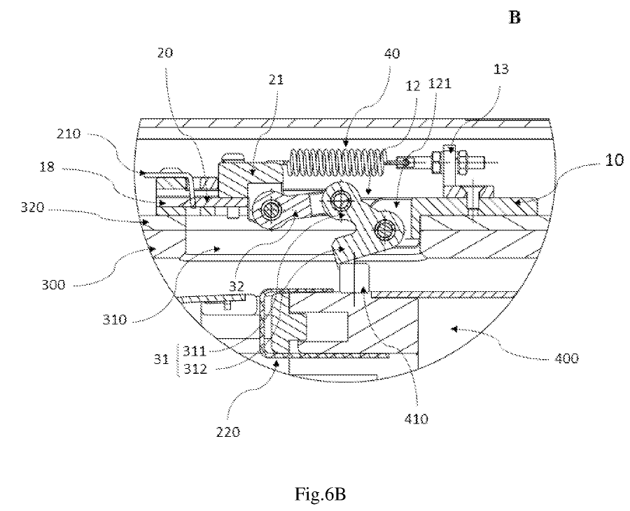

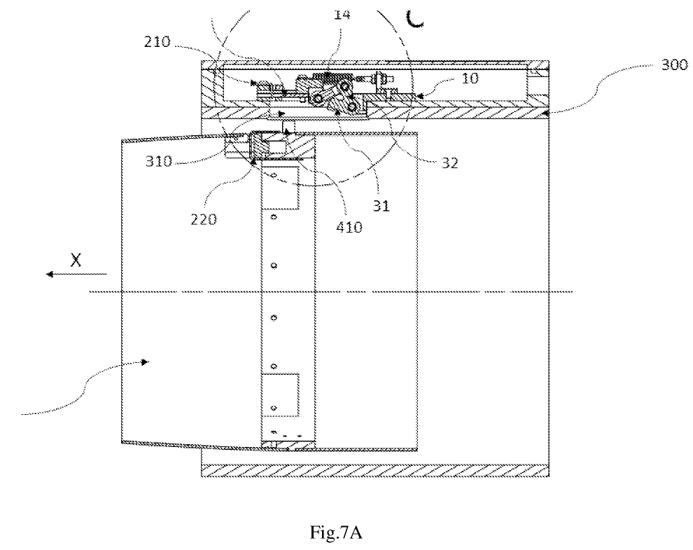

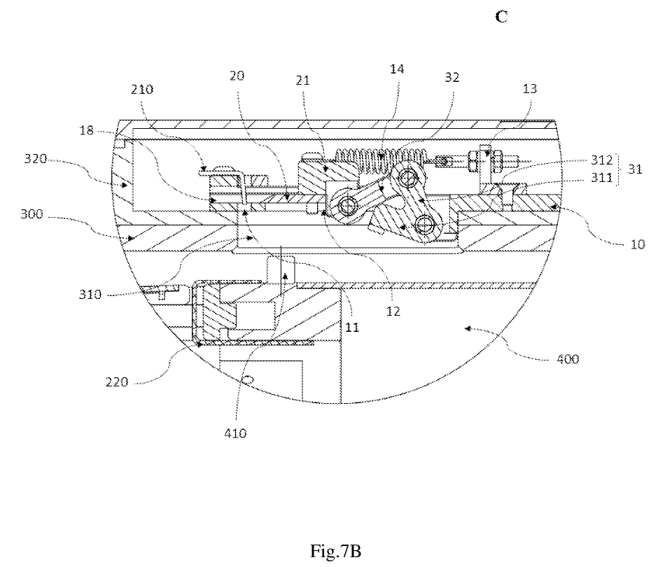

When activated, the flying device 400 moves forward in the direction of motion X as shown in FIGS. 6A to 7B, at this time the push pin 410 on the flying device 400 pushes the rocker arm 311 of the rocker arm 31 in the direction of motion X causing the rocker arm 31 to rotate from bottom to top around the first pivot 33a, then the rocker arm 312 of the rocker arm 31 through the crank 32 pushes the flat cutter 20 to move forward in the cutter groove 18.

During the first half of the stroke of the rocker arm 312, the push pin 410 is always in contact with the rocker arm 311 of the rocker arm 31 as shown in Fig.6A and Fig.6B, due to the pushing force of the push pin 410 on the rocker arm 311 of the rocker arm 31, the rocker arm 312 pushes the crank 32 so that the connecting end of the crank arm 32 and the rocker arm 312 reach up to position on the second opening 12, at this time the flat cutter 20 has the furthest travel amplitude and cuts through the umbilical cable 200 dividing the umbilical cable 200 into two parts, the first part 210 is retained on the guide tube 300 and the second part 220 on the flying device 400, at which time the electrical and/or communication connection between the flying device and the power source and/or controller is completely disconnected. At the same time, during the first half of the stroke of the pusher arm 312, the elastic means 40 are increased in tension due to the springs being stretched compared to the original. In the latter half of the stroke of the push arm 312, when the push pin 410 slides past the free end of the trigger arm 311, the tension of the elastic means 40 pulls the flat cutter 20 backward to push the crank arm 32 obliquely upward to the second opening 12, causing the push trigger 31 to rotate around the third pivot pin 33c to its full amplitude upward, at this time the free end of the trigger arm 311 of the push trigger is pulled into the opening 310 of the guide tube 300 and is held fixed in this position so as not to collide with the rear part of the aircraft 400.

The invention has been described in detail above according to the preferred embodiments. A person with average knowledge of the art can make changes and modifications based on the described embodiments. Therefore, these changes and modifications are considered to be within the scope of the invention as defined in the following accompanying claims.

1. An umbilical cable cutting device comprises:
a base platecomprising a first openingfor receiving the umbilical cable and a second opening of a rectangular shape located behind the first opening; an upper surface of the base plate having a knife track formed from a middle of the second opening extending laterally and extending through the first opening towards a front edge of the base plate; a stop plate attached to the upper surface of the base plate such that the stop plate blocks at least a portion of an upper part of the knife track;
a flat cutter having a knife stand, the flat cutter is mounted in the knife track and can move along the track by means of a drive mechanism arranged in a space inside the second opening;
the drive mechanism is structured to include:
a push rod in a V-shape consisting of a trigger arm and a push arm , the push rod being rotatably attached to the rear horizontal edge of the second opening at its V-shaped bottom position by a first pivot,
the crank having its first end connected to the knife holder of the flat cutter and its second end connected to the push arm of the push rod by a second pivots and a third pivots, respectively;
at least one elastic means arranged on the base plate to elastically pull the flat cutter towards the rear of the second opening.

2. The umbilical cable cutting device according to claim 1, wherein the elastic means has one end attached to the knife holder of the flat cutter and the other end attached to a threaded shaft on a holder, wherein the holder is fixed behind the second opening on the base plate.

3. The umbilical cable cutting device according to claim 2, wherein the threaded shaft is threadedly connected to the holder, each end of the threaded shaft is fitted with an adjusting nut for adjusting the increase/decrease of the pulling force of the elastic means.

4. The umbilical cable cutting device according to claim 1, wherein the number of elastic means is two.

5. An umbilical cable cutting device according to claim 1, wherein the elastic means is a spring.

6. An umbilical cable cutting device according to claim 1, wherein the base plate further comprises a pair of mounting ears fixed to the rear horizontal edge of the second opening, wherein the push trigger is rotatably attached to the pair of mounting ears via a first pivot pin.

7. An umbilical cable cutting device according to claim 1, wherein the device further comprises a clamping element fixed to the base plate to secure the umbilical cable from moving backwards against the blade of the flat cutter.

8. An umbilical cable cutting device according to claim 1, wherein the flat cutter or at least the blade portion of the flat cutter is made of non-metallic material to avoid short circuit when cutting the umbilical cable.

9. An umbilical cable cutting device according to claim 1, wherein the rear face of the trigger arm is recessed with a profile suitable for the ejector pin on the aircraft.
